(19) United States
(12) Patent Application Publication
(10) Pub. No.: US 2016/0132132 A1
(43) Pub. Date: May 12, 2016

(54) Systems And Methods For Generating Temporary Button On Display

(71) Applicant: Chian Chiu Li, Fremont, CA (US)

(72) Inventor: Chian Chiu Li, Fremont, CA (US)

(21) Appl. No.: 14/935,448

(22) Filed: Nov. 8, 2015

Related U.S. Application Data
(60) Provisional application No. 62/077,318, filed on Nov. 10, 2014.

(51) Int. Cl. G06F 3/0346; G06F 3/0481; G06F 3/0484; G06F 3/01

(52) U.S. Cl. CPC G06F 3/0346; G06F 3/017; G06F 3/04817; G06F 3/04842; G06F 3/013

(57) ABSTRACT

Systems and methods for presenting temporary virtual button on device screen. In an aspect, a temporary button or button window appears on screen after a user shakes, taps, or knocks a device lightly. In another aspect, the property of temporary button is automatically rearranged according to device location, device pointing direction, ongoing program at device, or a time period. A temporary button or button window only shows up for a short period of time and is arranged to be editable.

### FEDERALLY SPONSORED RESEARCH

Not applicable

### SEQUENCE LISTING OR PROGRAM

Not applicable

### BACKGROUND—FIELD OF INVENTION

This invention relates to operating electronic device, more particularly to providing temporary button for electronic device.

### CROSS REFERENCE TO RELATED APPLICATION

This application claims the benefit under 35 U.S.C. Sec. 119 of provisional patent applications Ser. No. 62/077,318, filed Nov. 10, 2014.

### BACKGROUND—DESCRIPTION OF PRIOR ART

Portable electronic devices have become ubiquitous, as an indispensible part of our daily life. Examples include smartphones, and potentially, smart watches, smart bands, and other wearable gadgets. For the convenience of performing various tasks and functions, corresponding buttons may be configured on device. There are physical hard (or hardware tactile) buttons and virtual (or soft) buttons. For small devices, hard buttons are usually arranged on the side of body or beside a display screen. Virtual buttons are mostly placed on the top or bottom part of a touch-sensitive screen. Functionalities of hard and virtual buttons are determined by manufacturer or vendor and may rarely be changed by users. Since there are many functions and applications installed at a device, only a small number of them, i.e., the most common and most used ones, may be selected and assigned to buttons. The chosen ones may be accessed by tapping a button directly and conveniently. But for the majority of functions, programs, and applications, a specific page has to be reached first, which may cost several steps and become a hassle occasionally.

In addition, small-sized portable and wearable device have a small screen besides a small body. Thus, only a few hard and virtual buttons may be arranged, because objects crammed in a limited space may cause distraction and discomfort. Furthermore, users have different habits and thus each may have individual needs for buttons. Some may like a button assigned to one app, while others may like a button assigned to another app. To make things more complicated, user's needs of button may change with location, application, and time. For instance, a hiker on a hiking trail may want a button of map app, a user reading an electronic book may like a button of dictionary app, and a user in a gym may favor a button of fitness app.

Therefore, there exist a need for providing more buttons on small device and a need for providing button whose property is based on location, application, and time.

“Button” is used as identifier on a device, or graphic identifier, graphic object, or graphic icon on device screen. “Button” may be associated with an application, a program, a function, a computer file, or contents of computer information. Hard button may be configured on device, while virtual button may show up as graphic object on screen. Hard button may be activated when it is depressed. Virtual buttons may be activated when it is tapped by fingertip or clicked via computer mouse. Virtual button may also be activated by other methods, such as finger sliding on it or fingertip hovering over it. Once a button is activated, via tapping or sliding for instance, a corresponding application or program may be launched, a file may be opened, or certain contents may be presented. A button may provide an easy and convenient way to access application, program, file, or data. Normally, when a virtual button is visible on a device or screen, it may mean the button is accessible and executable.

### OBJECTS AND ADVANTAGES

Accordingly, several main objects and advantages of the present invention are:
a). to provide improved methods and systems to operate electronic device;
b). to provide such method and system which present temporary virtual button in a convenient and less intrusive way;
c). to provide such method and system which present temporary virtual button when shaking, tapping, or knocking act happens;
d). to provide such method and system which allow user to edit the property of temporary button; and
e). to provide such method and system which arrange or change button function or property automatically according to device location, device pointing direction, ongoing program, or a time period.

Further objects and advantages will become apparent from a consideration of the drawings and ensuing description.

### SUMMARY

In accordance with the present invention, methods and systems are proposed to provide temporary button on electronic device. A temporary button or button window may show up for a short period of time when a user shakes, taps, or knocks a device, or presses an existing button. Temporary button or button window may be edited by user. Button property may change automatically depending on device location, device pointing direction, a program in progress, or time frame. Temporary button may make it easy and convenient to access app, program, functionality, or info.

### DRAWING FIGURES

FIG. 1 is an exemplary block diagram describing one embodiment in accordance with the present invention.

FIG. 2 is an exemplary flow diagram showing one embodiment of creating temporary button in accordance with the present invention.

FIG. 3 is an exemplary flow diagram showing one embodiment of creating temporary button in accordance with the present invention.

FIG. 4 shows an exemplary diagram to depict button window with multiple temporary buttons in accordance with the present invention.

FIG. 5 uses exemplary diagrams to show one embodiment of generating temporary button in accordance with the present invention.

FIG. 6 is an exemplary diagram showing four types of special temporary button.

FIG. 7 shows an exemplary diagram describing a method of presenting temporary button.

FIG. 8 shows exemplary diagrams illustrating generation of temporary buttons in three cases.

FIGS. 9-A and 9-B exemplarily show a method of presenting temporary button.

FIGS. 10-A and 10-B contain two exemplary diagrams to show device pointing direction.

FIG. 11 shows exemplary method to determine pointing direction of smartphone.

REFERENCE NUMERALS IN DRAWINGS

| | |
|---|---|
| 10 Sensor | 12 Device |
| 14 Processor | 16 Computer Readable Medium |
| 18 Sensor | 20 Sensor |
| 22 Sensor | 24 Button Window |
| 26 Smartphone | 28 Button |
| 30 Button | 32 Smartphone |
| 34 Button | 36 Smartphone |
| 38 Camera | 40 Camera |
| 42 Button | 44 Smartphone |
| 46 Button | 48 Smartphone |
| 50 Smartphone | 52 Button |
| 54 Finger | |

110, 112, 114, 116, 118, 120, 122, 124, 126, and 128 are exemplary
steps.

### DETAILED DESCRIPTION

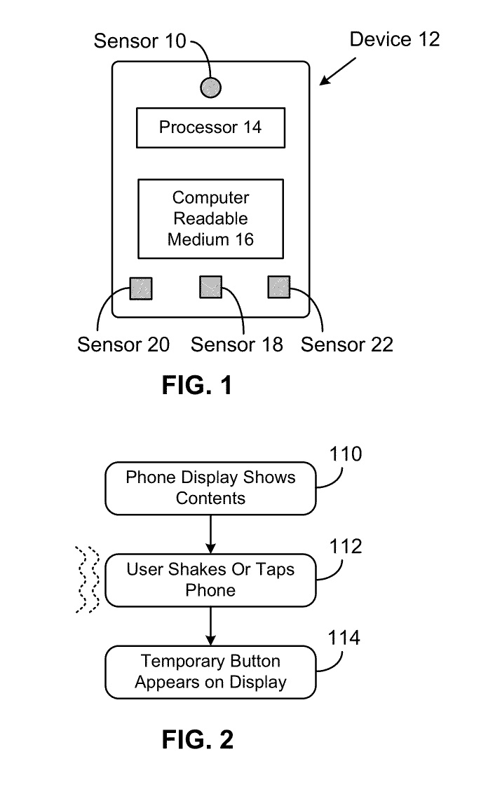

FIG. 1 is an illustrative block diagram of one embodiment according to the present invention. A device 12 may represent an electronic device, including but not limited to smart phone, smart watch, smart band, other wearable device, handheld computer, tablet computer, and the like. Device 12 may include a processor 14 and computer readable medium 16. Processor 14 may mean one or more processor chips or systems. Medium 16 may include a memory hierarchy built by one or more memory chips or storage modules like RAM, ROM, FLASH, magnetic, optical and/or thermal storage devices. Processor 14 may run programs or sets of executable instructions stored in medium 16 for performing various functions and tasks, e.g., surfing on the Internet, playing video or music, gaming, electronic payment, social networking, sending and receiving emails, messages, files, and data, executing other applications, etc. Device 12 may also include input, output, and communication components, which may be individual modules or integrated with processor 14. The communication components may connect the device to another device or a communication network. Usually, device 12 may have a display (not shown in FIG. 1 for brevity reason) and a graphical user interface (GUI). A display may have liquid crystal display (LCD) screen, organic light emitting diode (OLED) screen (including active matrix OLED (AMOLED) screen), or LED screen. A screen surface may be sensitive to touches, i.e., sensitive to haptic and/or tactile contact with a user, especially in the case of smart phone, smart watch, and tablet computer. A touch screen may be used as a convenient tool for user to enter input and interact with a system. For instance, virtual buttons may be generated on a touch screen, which may be activated by tapping of fingertip conveniently. Furthermore, device 12 may have a voice recognition component for receiving verbal command or audible input from user.

A communication network which device 12 may be connected to may cover a range of entities such as the Internet or the World Wide Web, a local area network (LAN), a wide area network (WAN), a metropolitan area network (MAN), a telephone network, an intranet, wireless, and other types of networks. Device 12 may be connected to a network by various wired, wireless, optical, infrared, ultrasonic or other communication means.

Device 12 may also include a sensor 10 which tracks the eye movement or gazing direction of user using mature eye-tracking technologies. The sensor may be arranged on a device, or close to a display screen, and may be designed to have imaging capability. After taking images, a system may recognize whether user's eye is in such a position that the eye sight falls on the body of device 12 using certain algorithm. In other words, sensor 10 may be employed to determine whether a user is looking at the body or the screen of a device. Once it senses that a user is gazing or looking at a given target, it may records the starting time, and then the total gazing or watching time. Only when the gazing or watching time exceeds certain value, it may be declared that the user is gazing or looking at a target. As a consequence, a very brief look may be too short to qualify as gazing or watching event. In the following sections, it is assumed the total time satisfies the minimum value requirement when it is said gazing is detected.

Sensor 10 may be built using mature imaging technologies, such as camera module of smartphone, and the image of user's eye may be analyzed with mature algorithm to decide which direction a user is looking at. Both visible and infrared light may be employed for eye-tracking. In the latter case, infrared light source may be arranged to provide a probing beam. In addition, sensor 10 may also employ other suitable technologies which are capable and affordable other than the eye-analysis scheme discussed to determine the gazing or watching direction of user. In some applications, when the accuracy of gazing direction is not critical, a watching direction may be obtained via analyzing facial picture of user.

Device 12 may contain a sensor 18 which may employ accelerometers and gyroscopes to detect its own movement by sensing acceleration, deceleration, and rotation. Accelerometers and gyroscopes may be made using semiconductor technologies and are already mass manufactured and commonly used in smartphones and other personal gadgets nowadays. Using data produced by sensor 18, it may be determined whether device 12 is moved to the left, right, forward, or backwards, and at what speed, whether it is rotated clockwise or anticlockwise along which axis, and whether it is tilted to the left, right, forward, or backwards. The data may also be used to detect whether the device is moved back and forth as a result of shaking. In some embodiments in the following, shake is one state to be detected. A user may shake a device a bit as a way to give instructions. Furthermore, a user may also knock on a device to give instructions. Knocking on a device may cause vibration, which may be sensed by sensor 18 too.

In addition, device 12 may carry a positioning sensor 20 and a magnetic sensor 22. A positioning sensor may be a global positioning system (GPS). In practice, device position may be measured by other means too, such as wireless triangulation method, or other suitable technologies. Sensor 22, as electronic compass, measures the earth magnetic field along at least two orthogonal axes X and Y. It may be used to determine device orientation, such as which direction a device is pointing at. Most times, it is assumed that a device is placed in a horizontal position with display screen parallel to the ground. Once a device's location is known, a service center may send to the device location-based information, i.e., info related to the location or the nearby places. In the case of location-based advertising, a device may receive commercials when a user carrying it is at or close to a business. If a device's location and pointing direction are known, it may be determined which store or business lies ahead, or which product section is straight ahead inside a store.

Inside device 12, output signals of sensors and detectors are transmitted to processor 14, which, employed with certain algorithm, may process the data and produce subsequent command instructions according to installed computer programs. The instructions may include presenting location-based info, or an extra button on screen.

FIG. 2 shows a schematic flow diagram of one embodiment which provides temporary button for a device. Take smartphone to illustrate the principles. A smartphone is showing contents in Step 110. Next, a user uses hand to grab the phone and shakes it lightly or uses finger to tap the phone in Step 112. Tapping act in here may mean hitting the phone body lightly with a fingertip or an object for a couple of times. All components of the phone may experience the movement caused by shaking or tapping act, including a motion sensor equipped. Then in Step 114, a temporary virtual button may show up on the phone display. The virtual button may be executable so that tapping on it may invoke a program or app installed at the phone. A temporary button may stay on screen for a given short period of time, for instance, less than five to seven seconds. If the button is tapped, a program may be executed or a function be performed. If the button is not tapped or activated within the given short period of time, it may be arranged to disappear automatically. The button may be arranged to show up only after certain act like shaking or tapping is detected.

The process to show temporary button is simple and convenient. The button may remain invisible and may not take any screen space until being called out. Its appearance is temporary and brief, but helps operating a device in a user-friendly way. It is noted that, shaking may be in any direction, and a temporary button is better arranged at a place where a user is less likely to engage with, such as an empty spot on screen top or bottom area. A temporary button may be assigned to represent any app or function installed at a device like social networking, instant message, power off, standby, email login, news site, or sports news portal. A temporary button, as graphical object or icon on screen, may be arranged small and noticeable, but not very conspicuous so that its appearance is less intrusive. It may represent a program or app directly, i.e., tapping a button may be arranged to start a program or app. A temporary button may be associated with a button window as well. In such a case, tapping the button causes a window to show up, where several buttons may be configured for various programs and functions.

Temporary button may make it more convenient to operate a device and make better use of screen space. Unlike a fix hard or virtual button, it may appear at the same or different spot each time. Although a temporary button may show up at different places, it is preferred to remain around one area for easy finding and recognition. For instance, a temporary button may be arranged always in the top or bottom screen area. Thus a user may always look for temporary button in one area when a button is supposed to appear.

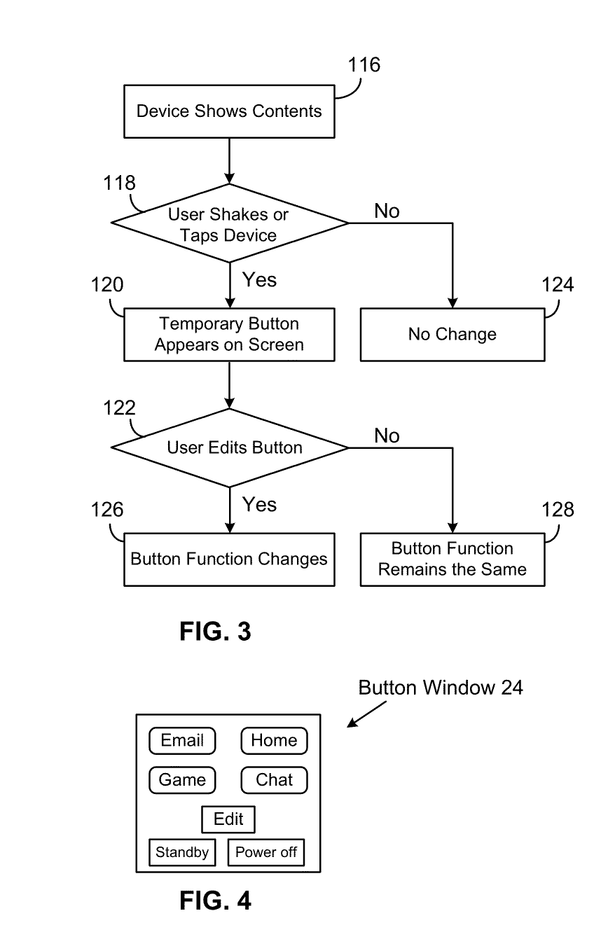

FIG. 3 illustrates a schematic flow diagram of one embodiment of generating editable temporary button on screen. Assume that a device is showing certain contents in Step 116. In Step 118, user input is detected. When a user shakes, taps, or lightly knocks the device, the act may be sensed almost immediately by the device, such as within a second. Shaking may be sensed by motion detector like sensor 18 of FIG. 1. Tapping and knocking may be directed to device body, which may cause device vibration and be sensed by detector like sensor 18 of FIG. 1 too. Additionally, tapping on an area of touch screen may be arranged as user request for temporary button too. For instance, it may be designed that if certain empty place is tapped, like the top part of screen, it may be considered as user command to show temporary button. Since a touch screen may have existing virtual buttons and active links, emerging temporary button shall keep a distance from those places.

In cases there is no shaking, tapping, or knocking act detected, the device screen may continue a presentation without any change in Step 124. If it is detected that shaking, tapping, or knocking happens, a temporary button may appear on screen in Step 120. A temporary button may appear at many places of the screen, though preferably at an empty spot to avoid unnecessary interference with the current activity of user. The button is also preferred to appear around one area only such that it is relatively easy to look for it. It may represent any function or program and may be designed to be editable, enabling user to change button property anytime. Button property may include button shape, size, color, appearance place, length of appearance time period, function assigned, app assigned, or program assigned. Moreover, buttons of different functionalities or a window containing buttons may pop up instead of a single button. An example of popup window is depicted graphically in FIG. 4. As in the drawing, a button window 24 may be arranged to contain several buttons corresponding to various applications and functions, such as “Email”, “Home”, “Game”, “Chat”, “Edit”, “Standby”, “Power off”, and Close buttons. Close button, not shown in the figure for brevity reason, may be a letter-x-shaped icon configured at the upper right corner of the window. When Close button is tapped, the button window may close. “Standby” and “Power off” buttons, representing power management functions, may be used to start standby state and turn off the power of device respectively. The “Edit” button may be used for editing button or button window property such as contents, appearance, and mode. For instance, a user may tap “Edit” button to enter an editing page, where, for instance, the user may change the property of “Game” button and assign a different game app to it. The editing page may also be arranged to have an option to turn off temporary button mode. When temporary button mode is off, temporary button may not show up. The editing page may be accessed via device setup page so that a user may have an option to turn on temporary button mode after the mode is turned off. Options may also be arranged on editing page to restrict certain kinds of temporary buttons. For instance, a user may select an option to block temporary button related to advertisement. Back to FIG. 3. If a user doesn't want to edit button or window property in Step 122, button property may remain the same in Step 128. A user may tap a temporary button to start an application. If a user would like to change button function or window configuration, he or she may do so in Step 122. Consequently, button or window property may change accordingly in Step 126.

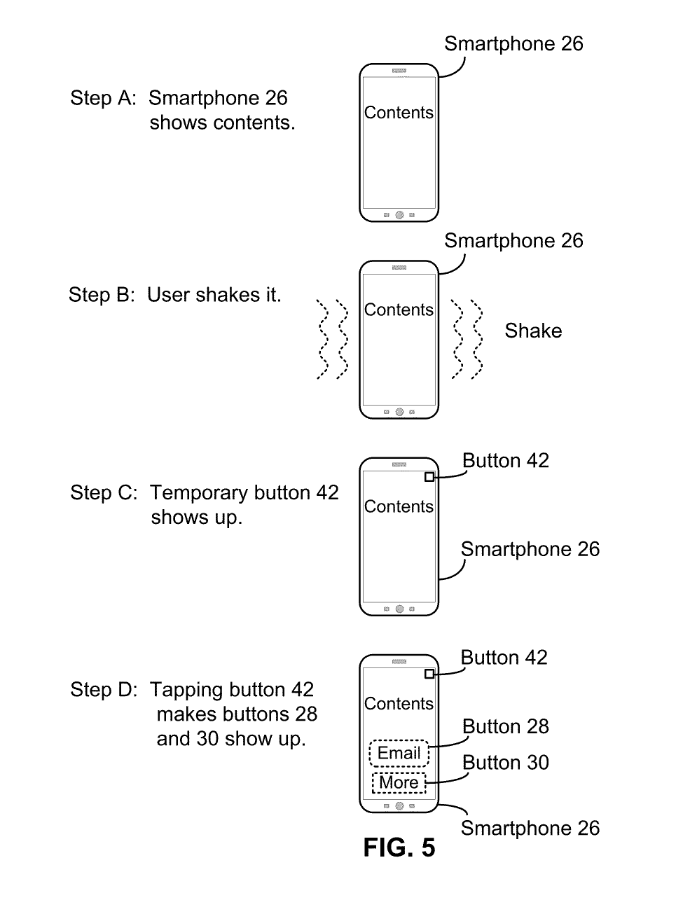

FIG. 5 uses graphic diagrams to show another embodiment of generating temporary virtual button. In the example, a smartphone 26 is used for explanation purpose. It starts with Step A when phone 26 shows certain contents on display. In Step B, a user shakes phone 26, which is detected by the phone. Then in Step C, a temporary button 42 shows up. Button 42 may be arranged to represent a program or function. A user may tap button 42 to invoke it directly. On the other hand, button 42 may also represent buttons 28 and 30 as shown in Step D. Activating button 42 may cause the phone to show buttons 28 and 30 together on screen. Assume that an email app is assigned to button 28 which may be frequently used by the user, and request for more buttons may be assigned to button 30. It may be designed that when button 28 is tapped, an email app may be launched or an email program activated, which may provide an easy and convenient way to check emails. When button 30 is tapped, more temporary buttons or a button window like the one of FIG. 4 may show up on display. Button “More” or button 30 may serve as a gateway to other functions and applications. As buttons 28 and 30 and other buttons only show up when requested, it makes screen less crammed. As an alternative, shaking phone 26 may be arranged to cause display of buttons 28 and 30 directly. Direct display of relatively sizable button such as button 28 or 30 or button window may be liked by some users, but may bother other users when it is accidentally initiated.

Comparing to buttons 28 and 30, button 42 may be designed smaller, without tag of full name, and less conspicuous. For instance, button 42 may be arranged smaller than five to seven millimeters in width and height. Its shape options may be limited due to small size, even though it may have many shape designs and be associated with many programs and functions. Button 42 may flash once or a couple of times after emerging, but not more than that, and it is preferred not to have color too brighter than the background. So when button 42 shows up by inadvertent shake or knock act, it may not attract too much attention from an unprepared user and may not interfere with user's activity to a certain degree. Button 28 or 30 may be arranged much larger in size. They may be designed to have an area that is at least one and a half times the area of button 42. They may have specific shape, logo, and full-name tag, and may be much more noticeable than button 42. If button 28 and 30 appear on screen without invitation, which may happen with accidental shaking or knocking event, they may become a nuisance for some. Thus when shaking or knocking act happens, some users may like to arrange button 42 to show up first. Once button 42 is tapped, buttons 28 and 30 may appear. Thus appearance of extra button may hardly annoy users no matter what happens. So button 42 may function as a buffer to prevent surprise disruption to a presentation as a result of accidental moves. The disruption may overwhelm the benefits of temporary button.

In cases when a user changes mind after noticing buttons 28 and 30 on screen, the user may tap button 42 again to make button 28 and 30 disappear, assuming that button 42 remains there along with buttons 28 and 30. Buttons 28 and 30 may also be arranged to disappear when another on-screen button or icon is activated after their appearance. They may disappear by themselves if no user input is detected for certain time too. When buttons 28 and 30 become invisible on screen, it may be designed that button 42 may disappear as well.

In above description, a user just needs to do one thing, shaking a phone lightly, and then a button may appear on display. As the button may be arranged editable, a user may associate it with his or her favorite app or program so that it becomes easy and convenient to launch selected app or program anytime.

As discussed, once a device is shaken, tapped, or knocked, extra button or button window may appear on screen. The button or button window may have the same property such as representation of function, program, or app unless a user makes change to it. The decision to change may come from the need to use certain new function or program. Once there is additional need, change of button property may be desired. But in real life, user's need may change temporarily, recurrently, and frequently, depending upon location, program in progress, and time. For instance, event attendee may want to visit an event website to get info after arriving at the scene; a shopper may need a coupon app during shopping; and an employee may regularly use a workout app after work. Thus, a user may feel a need or urge for some app or function in certain circumstance or time frame. It is helpful to provide a button for app or function when a user is likely to run the app or use the function. But it may be impractical to adjust button property manually to fit a temporary need each time. Thus, it may be useful if button property can change automatically according to where a user is, what time it is, and what he or she is doing with a device.

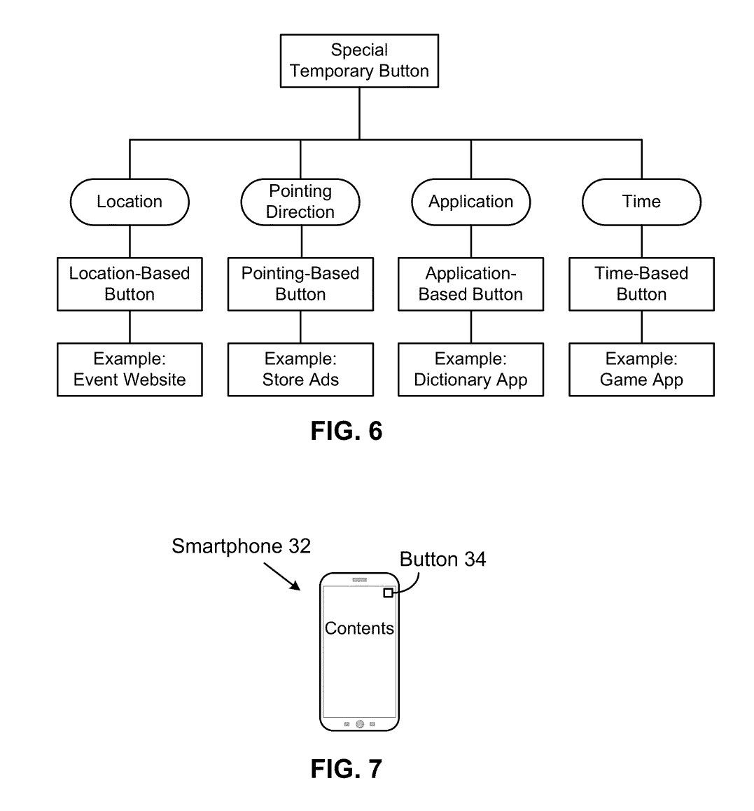

FIG. 6 schematically describes different types of special temporary button. Aforementioned buttons are related to often-used programs or apps, such as certain email or chat app, and not related to specific event, location, or time period. They may be defined as regular temporary buttons. Sometimes, it is convenient for user if a temporary button may be prepared for a special event, even though it may be needed for a certain period of time only. Otherwise, a user has to spend time searching for event info. But such a button may have little use on other occasions and thus may not need to appear after the event ends. To resolve the dilemma, special temporary button may be created, which may show up only at certain location for a temporary purpose. Special temporary button may be an additional virtual button relative to the regular button lineup which is preset and always there, but doesn't affect the arrangement of regular button setup. It may be arranged to appear individually or together with regular button when a device is shaken, tapped, or knocked lightly, or a button such as button 42 of FIG. 5 is tapped.

As shown in FIG. 6, special temporary button may have four types related to device location, device pointing direction, application or program which is running at device, and time respectively. Device location may be obtained by GPS or other position sensing system. Device pointing direction may be measured by magnetic orientation sensor like sensor 22 of FIG. 1. Take smartphone for example. A phone may be in a horizontal position, or vertical position. If a phone is in horizontal position, with its display screen horizontal and parallel to the ground, a pointing direction is what its front end points at in a horizontal plane. For a phone in vertical position, a pointing direction is what its back side points at or its rear-side camera points at, which is the opposite direction of what its screen faces. More discussions on pointing direction are in a section below.

First, a special temporary button may be location related. It may represent a location-based app or function automatically after a user arrives at a place. For instance, after a user enters an event site, he or she may shake a smartphone to pop up an extra event button or a button window containing an event button. The event button is of special temporary button. Assume a positioning function is already on. When a service provider knows a user arrives at the site, location-based info and programs may be prepared, which may include info related to location-based event button. The service provider may transmit the info to the smartphone in advance. Thus once the user shakes the phone, an event button or a link to event button may be presented quickly. An event button may be displayed individually or together with other buttons inside a temporary button window. Once the event button is tapped, for example, event web page may show up. If the event button or any button in the button window is not tapped in a given time period, say five to seven seconds, the button or button window may disappear automatically. The event button may be arranged to show up only around the event area. Thus it provides convenience to access location-based info, while doesn't cause any issue elsewhere when the event info is less likely in need. Similarly, once a user comes close to a movie theater, a special temporary button may be automatically assigned to represent a show-time app which may introduce movie schedules. For instance, a user may knock on a smartphone, and then tap a show-time button to view movie info.

Second, a special temporary button may be associated with device pointing direction. For instance, a user may point a device at a store, and then knock it lightly. Once it is detected that the user is in an area, location-based info may be retrieved at a service facility. The info may include electronic local map and popular apps selected for the area, and may be passed to the device. After knocks are sensed, the device may be designed to check its location again plus measuring orientation. Then either the device or the service facility may figure out which place or business the device is pointing at by certain algorithm. Assume the device senses that the pointed target is a store. Next a button window may pop up with an extra store button designated for the store. When the store button is tapped, ads, coupons, and other info of the store may show up. In another design, a store button assigned to the store may appear on screen directly after shaking act is sensed. The button may be a link to store web page. In a third design, a button which appears after a device detects shaking or knocking is only a link to a button window. So a user may point a smartphone at a store, shake the phone a bit, tap an emerging button to pop up a button window, find a store button in the window, and then tap on the store button to get desired info.

Third, a special temporary button may be related to a program or application in progress at a device. For instance, when a user logs on a news website, two special temporary buttons may be arranged to represent a dictionary app and a map app respectively. So after a device detects that a logged-on website mainly shows domestic and international news, special temporary buttons may be prepared to represent dictionary and map apps. When a user taps the device, the two buttons may be arranged to show up on screen. The user may tap a button to launch an app conveniently. A dictionary app may also be enlisted temporarily, when it is detected that an app of electronic book is launched.

Fourth, a special temporary button may be related to a time period. For instance, a game enthusiast may arrange a special game button which may appear on screen only in evening time, weekends, and holidays. Thus when a phone is shaken in after-work hours, a game button may appear on screen. One tap on the button may start or resume a game session.

Therefore, a special temporary button may behave in a “smart” way and be arranged to provide easy access to certain app or function when it is likely needed. And a special temporary button may be arranged not to show up to bother a user when it is less likely desired. In some cases, more than one type of special temporary button may fit predetermined conditions. For instance, when a user attends an event at evening time, both event-related button and time-related button may meet the condition to show up. So when the user shakes or knocks a device, two extra buttons may appear on device screen for user to choose.

The benefit of displaying temporary button by shaking, tapping, or knocking act is that a button doesn't take any screen space when not needed, while still remains accessible in a convenient manner. But some users may like a permanent button on device, either a hard one or virtual one, so that accessing temporary button may become simpler and more straightforward. For such a purpose, a button may be configured on screen or on device. The button may stay at a place for easy access. Tapping the button may have the same effect as shaking or knocking a device. For instance, an exemplary case is shown in FIG. 7. Assume a smart phone 32 is the device in use. A small button 34 may be arranged on the top part of display screen. Button 34 may have a label with a few letters or numbers, or have no label. In fact, button 34 may appear with the same feature as button 42 of FIG. 5, in terms of shape, color, and size. Once button 34 is tapped, a bigger button or button window with multiple bigger buttons may pop up and stay on screen for a given short period of time. The area of bigger button may be arranged to be at least one and a half times that of button 34. The bigger buttons may have individual shape and label design, like buttons shown in FIGS. 4 and 5. Thus, tapping button 34 may cause pop-up of extra button or button window with features as described in the above discussions. As button 34 has a fixed position, it is easy to find and convenient to use. It may be arranged that the popped-up button or button window may disappear when button 34 is tapped again. The deleting scheme may find use when a user no longer wants to use or view a temporary button or button window.

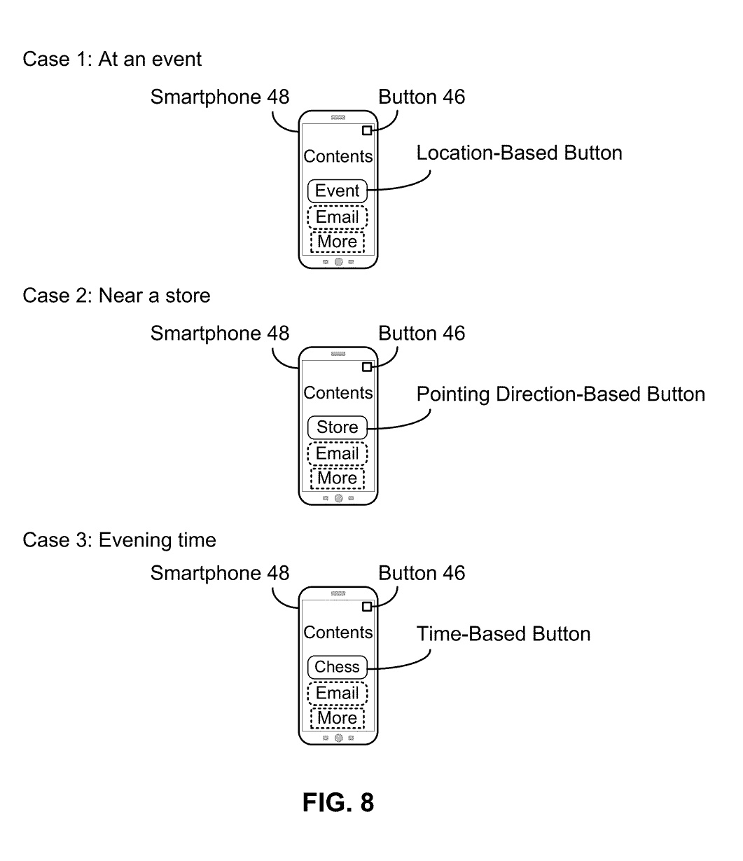

FIG. 8 shows graphically presentation of temporary button using a fixed button. A smartphone 48 is used for illustration. At the upper right corner of phone screen, a small fixed button 46 is configured. When button 46 is pressed or tapped, bigger button or button window may appear, just like what tapping temporary button 42 may trigger in FIG. 5. Also like what discussed in FIG. 6, special temporary button may be arranged for a location, a pointing direction, or a time frame. For instance in case 1, assume that a user arrives at an event site. When button 46 is tapped, three bigger buttons may show up. Two regular buttons, such as “Email” and “More”, may be arranged to be there all the time, while “Event” button may be a special temporary button which only appears when the phone is at the event site. For instance, after a user leaves the event area, and assuming there is no other event which may trigger an extra button, only “Email” and “More” buttons may come out when button 46 is tapped. The additional “Event” button may lead to event webpage, providing useful info to user with convenience.

In case 2, assume that a user is close to a store. The user may point the phone at the store and then tap button 46. As the location and orientation of phone 48 may be measured already, certain algorithm may be employed to determine what the phone is pointing at. Next it concludes that the phone points at a store. Then the phone may be arranged to display regular “Email” and “More” buttons, plus an extra “Store” as special temporary button. When “Store” button is tapped, store ads, coupons, and website link may emerge on screen. The method provides an easy and convenient way to access location-based info, without the need of entering key words and conducting a search. Once the user points the phone at another direction and then taps button 46, the “Store” button may disappear and another button, representing another entity or application related to the new direction, may emerge on screen.

Case 3 describes a time-based special temporary button graphically. Assume that a user likes to play chess after work. The user may edit the property of temporary button and assign a chess app to temporary button between 6:00 pm to 11:00 pm every weekday and for the whole day in weekends and holidays. Thus when button 46 is tapped in evening time, a “Chess” button may appear along with “Email” and “More” buttons. The user may tap “Chess” button to enter an online chess match.

In above cases, if shaking or knocking act, instead of tapping of button 46, is detected, temporary buttons may be arranged to emerge in the same manner.

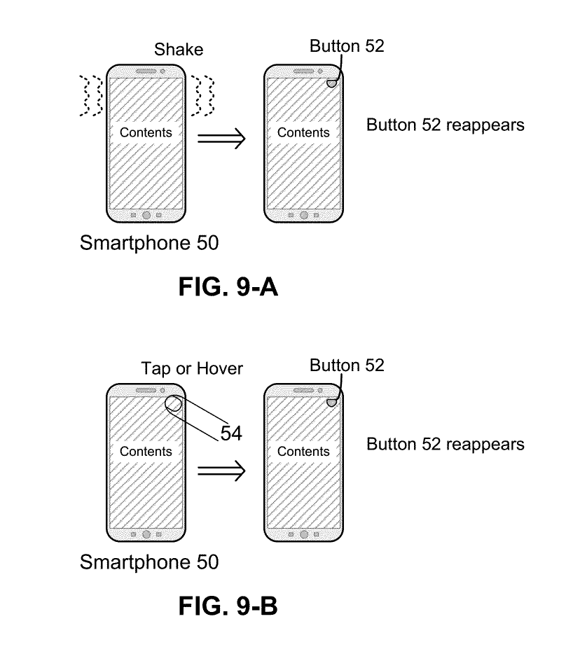

FIGS. 9-A and 9-B show schematically another embodiment to present temporary button. FIG. 9-A reflects what discussed in the above sections. Assume that a smartphone 50 shows some contents. When a user shakes the phone lightly, a small temporary button 52 may be arranged to show up on phone screen for a brief period of time. Button 52 may represent a program, function, or app directly. The button may also represent other temporary buttons or a button window containing temporary buttons with larger size. As aforementioned, button 52 may show up repeatedly when shaking, tapping, or knocking act is detected by the phone. When button 52 is activated by tapping, an app may be launched, or larger buttons may be presented. FIG. 9-B describes graphically another method to display a small temporary button. A user may make button 52 emerge by shaking the phone lightly. After a couple of times, it may become known that the button may show up at a place at the upper right corner of display screen each time. Then it may be designed that when a finger 54 taps the spot where button 52 appeared previously after shaking act, button 52 may emerge. Similarly, it may be arranged that when finger 54 hovers over the spot, button 52 may come out too. As button 52 may emerge at the upper right corner repeatedly, a user may easily remember where it is located or where it might appear. And some users may like tapping a spot or using fingertip to hover over a spot, instead of shaking or knocking the phone. The method may be implemented easily and give users another choice. It is noted that tapping on a screen spot is different from tapping on a device body which is introduced in above sections, even though both may belong to tapping in a general sense, and both may make a button emerge. Methods of displaying button using the two tapping techniques may coexist at a device.

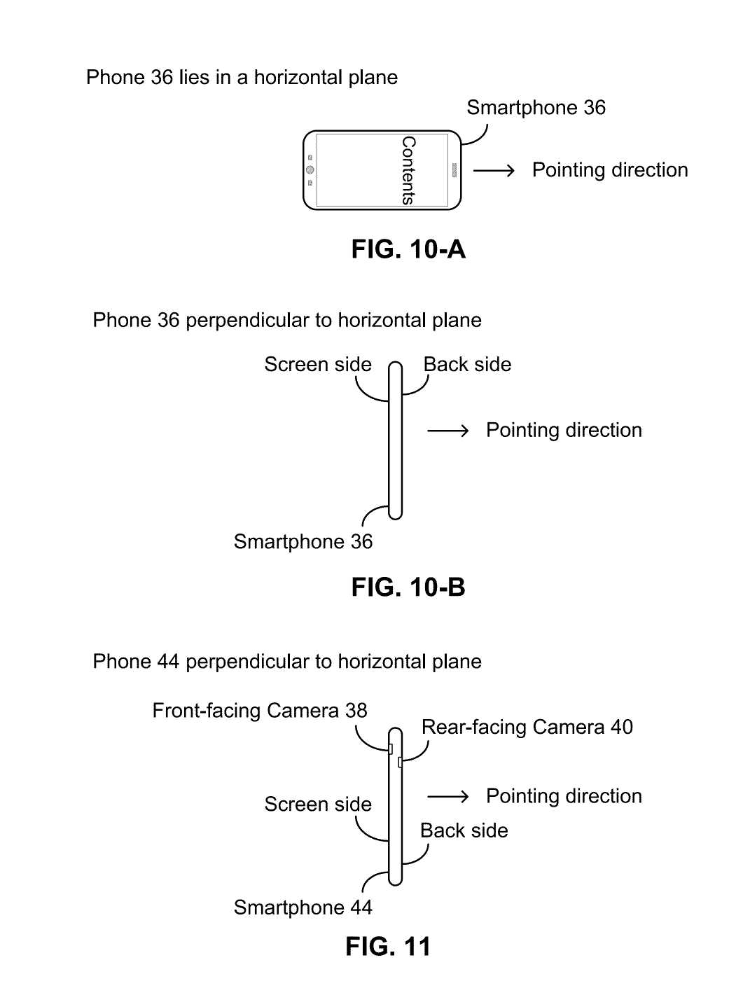

FIGS. 10-A and 10-B illustrate schematically pointing direction of smartphone in two situations. The principles may apply to other types of device. In FIG. 10-A, a smartphone 36 is placed with display screen parallel to the ground, i.e., a horizontal plane. As shown in the figure, a pointing direction may be defined as what the front end points at. In most discussions in the above, it is assumed that a device screen is in a horizontal plane, like in FIG. 10-A.

In practice, a device may be held tilted relative to a horizontal plane. Thus, device pointing direction may contain three components relative to three orthogonal axes, X, Y, and Z. Arrange X and Y axes in a horizontal plane. Let X-axis point straight ahead, Y-axis point left, and Z-axis point upward vertically. When a device is tilted, tilting or rotating around X-axis and Y-axis may be detected and subsequently ignored. Device orientation and pointing direction is measured by an angular value around Z-axis. In cases afore-discussed, tilting phenomena are not mentioned since they don't affect principle elaboration.

In FIG. 10-B, phone 36 is held vertically, with screen plane perpendicular to the ground. Its pointing direction may be defined as what its back side points at, while the screen faces in the opposite direction or faces a user.

To determine which direction a device points at, both location and orientation info are required, since a pointing line starts from a device and goes along pointing or orientation direction. In many cases, GPS and electronic compass may provide info needed. But in an indoor environment, GPS signals become unavailable and the magnetic field may be shielded or weakened by building structures. Usually there are methods to substitute GPS scheme, but orientation determination may become difficult to do. On the other hand, the image of indoor setting may be stable, unaffected by weather and seasons, and may be acquired in advance. Thus another way to sense pointing direction may combine positioning and imaging techniques. Assume a smartphone 44 has a front-facing camera 38 and rear-facing camera 40, as shown graphically in FIG. 11. Assume the phone is in a vertical position with phone screen perpendicular to the ground. In the figure, phone 44 points towards the right with back side and camera 40 facing right. First, phone 44's location may be obtained. Meanwhile, camera 40 may be arranged to take one or multiple pictures of scene in front of it. The pictures may be analyzed by specific algorithm and compared with pictures taken previously at the place. Then another algorithm may be used to determine which direction the phone faces or points at, and device pointing direction may be obtained. The same method also applies to an outdoor environment, while pictures with different focusing distances for scenes nearby and faraway may be taken automatically for analysis. In both indoor and outdoor environments, front-facing camera 38 may be utilized to take pictures in the opposite direction simultaneously. The pictures may be analyzed similarly and may help get more accurate orientation result.

### CONCLUSION, RAMIFICATIONS, AND SCOPE

Thus it can be seen that systems and methods are introduced to provide temporary virtual button for easy and convenient use of device.

The improved method and system have the following features and advantages:
(1). Temporary buttons are arranged to show up briefly when a user shakes, taps, or knocks a device;
(2). Button property and arrangement are editable;
(3). Special temporary button is arranged automatically based on device location, device pointing direction, program in progress, or time frame.

Although the description above contains many specificities, these should not be construed as limiting the scope of the invention but as merely providing illustrations of some of the presently preferred embodiments. Numerous modifications will be obvious to those skilled in the art.

### Ramifications:

As discussed in the above, shaking, tapping, and knocking act may be used as user command to present temporary button or button window. After a button or button window appears, similar shaking, tapping, or knocking act may also be used to remove the button or button window from screen. For instance, after a user shakes a device by accident, which may cause unwanted appearance of extra button on screen, the user may shake it again to make the button disappear.

There may be arranged two size groups of temporary button in general, i.e., small size and large size. Examples of small-size button include button 42 of FIG. 5 and button 46 of FIG. 8, while large-size buttons include “Email” and “More” in those figures. The boundary between small and big sizes may be arranged to be five to seven millimeters or less, or another value selected by user or manufacturer. The small and large size may also be defined in relative terms, such as by ratio of area as discussed before. For instance, a large-size button may mean its area is at least one and a half times the area of small-size button. Merits of small-size button may include reduced intrusiveness, reduced annoyance, and fitting a small screen. A large-size button may be designed to have a distinctive shape with an elaborate name tag for each function or program. A small-size button may be designed to have distinctive shape for specific function or program as well, but with no label or a few letters or numbers as label. In other words, a small-size button may be arranged to have a unique shape, pattern, feature, or color for a special function, but without a full-name description. Some user may prefer the same appearance of small-size button for all occasions for simplicity reason. It may be designed that the property of both large-size and small-size buttons, including appearance, may be edited or changed by user. When special temporary button is available, a small-size button may be arranged to appear differently to reflect the change automatically, which may apply to both button 42 and button 46. For example, a small-size button may be a small circle-shaped icon, which may be a link to one or more regular temporary buttons. When a special temporary button comes, “1” may be shown inside the circle. If later on, two special temporary buttons become available, “2” may replace “1” automatically to show the situation. The circle may be filled with a color which may change when the button property changes. Moreover, two small-size buttons may appear together to represent two programs respectively, or represent special and regular temporary buttons separately. For instance, there may be two buttons 42 in FIG. 5 or two buttons 46 in FIG. 8, and the two side-by-side buttons may have the same or different appearance features. Additionally, the two small-size buttons may be activated individually or together. In the former case, one button may be activated exclusively and directly, while in the latter case, the buttons work as one icon which may present two large-size buttons or a button window for user to view and choose.

Ambient light sensor may be added to a device which may be used to sense ambient light intensity to determine whether the device is in a pocket or bag. If a device is in a pocket or bag, shaking signals may be ignored and a temporary button will not appear.

Furthermore, a device may be equipped with facial recognition system. The system may at least recognize the device owner, which may protect a user's privacy by not following other people's instructions. The system may make use of the camera of eye-tracking or front-facing camera and employ facial sensing algorithm to identify a user.

In examples described in the above, shaking, tapping, or knocking act is used as user command to illustrate various embodiments. It is noted that other forms of user input, such as rotating, tilting, or touching may also be employed to perform the same function. Still other means for user to interact with a device may include sliding on a touch screen or touch pad. Thus, temporary button may be arranged to come out after a device is rotated, tilted, or finger sliding happens on device screen.

Eye-tracking or gaze detection may be incorporated in foregoing schemes. For instance, it may be designed that shaking plus gazing at device display, instead of shaking act alone, may invoke pop-up of virtual button. For instance, there may be one more step inserted between Step 112 and 114 of FIG. 2, or Step 118 and 120 of FIG. 3. The new step is to detect whether a user gazes at device screen. If gaze at device screen is detected for a given period of time, a button may appear on screen; but if gaze towards the screen is not detected, or the time of gaze is shorter than a certain value, a temporary button may remain hidden. With gaze detection, the chance of unintended appearance of virtual button is reduced.

It may be designed that when a user taps another place after a temporary button shows up, indicating the user has no interest in the new button, a just-appeared button may be removed from screen immediately. When there is no action for a given period of time, the new button is removed automatically from screen too, since it indicates that the user has little interest in it. But when it is detected that a user is gazing at device screen, and there is no action of user, the button or button window may stay longer than when there are neither gaze nor action, since there is a chance the user is looking at the button or button window and hasn't decided the next move yet.

Among steps discussed in the above, one of them is to determine whether a user is gazing at device screen. But in cases of wearable device which may have small dimensions, the step may be replaced by checking whether gazing direction is at the device itself, as watching a device body may equal to watching device screen.

Example discussed in FIG. 9-B uses finger hovering as user instruction to present temporary button. Act of finger hovering over an object on screen may mean placing a fingertip above the object while keeping a small spacing between the fingertip and the screen surface.

Lastly, voice of user may be used to replace device movement like shaking or vibrating as input. For instance, a user may say “Button” to a device, which may be treated as user request to present temporary button or button window on screen.

Therefore the scope of the invention should be determined by the appended claims and their legal equivalents, rather than by the examples given.

1. A method performed for operating an electronic device having a display and stored executable instructions comprising:
1) showing a plurality of contents on said display;
2) detecting physical movement of the device body;
3) sensing the pattern of said movement;
4) determining whether said pattern matches predetermined criteria; and
5) presenting for a given short period of time at least one predetermined graphic object or a window comprising at least one predetermined graphic object using said display when said criteria are matched, said at least one graphic object arranged for implementing a predetermined function or launching a predetermined program when activated.

2. The method according to claim 1, further including providing options for a user to edit the property of said at least one graphic object or said window.

3. The method according to claim 1 wherein the property of said at least one graphic object is arranged to be determined partially by the location of said device, the pointing direction of said device, said plurality of contents, and/or the time when said determining step is performed.

4. The method according to claim 1, further including detecting the gaze direction of a user, said criteria arranged to include a given gaze direction.

5. The method according to claim 1, further including presenting a plurality of graphic icons when said at least one graphic object is activated, said plurality of icons arranged for performing respective functions or starting respective applications or programs when activated.

6. The method according to claim 1 wherein said movement includes shaking or vibration.

7. The method according to claim 1, further including making said at least one graphic object or said window disappear if said pattern is detected again within said given short period of time.

8. A device having a display and stored executable instructions, comprising:
1) presentation means for presenting a plurality of contents on said display;
2) detecting means for detecting the physical movement of said device;
3) sensing means for sensing the pattern of said movement;
4) first mechanism for determining whether said pattern matches predetermined criteria; and
5) displaying means for presenting for a given short period of time at least one predetermined graphic object or a window comprising at least one predetermined graphic object using said display when said criteria are matched, said at least one graphic object arranged for implementing a predetermined function or launching a predetermined program when activated.

9. The device according to claim 8, further including editing means for editing the property of said at least one graphic object or said window.

10. The device according to claim 8 wherein the property of said at least one graphic object is arranged to be determined partially by the location of said device, the pointing direction of said device, said plurality of contents, and/or the time when said first mechanism is performed.

11. The device according to claim 8, further including detecting the gaze direction of a user, said criteria arranged to include a given gaze direction.

12. The device according to claim 8, further including icon means for presenting a plurality of graphic icons when said at least one graphic object is activated, said plurality of icons arranged for performing respective functions or starting respective applications or programs when activated.

13. The device according to claim 8 wherein said movement includes shaking or vibration.

14. The device according to claim 8, further including a second mechanism for making said at least one graphic object or said window disappear if said pattern is detected again within said given short period of time.

15. A method performed for operating an electronic device having a display and stored executable instructions comprising:
1) presenting a plurality of contents on said display;
2) arranging a button on said display;
3) presenting for a given short period of time at least one predetermined graphic object or a window comprising at least one predetermined graphic object using said display when said button is activated, said at least one graphic object arranged for implementing a predetermined function or launching a predetermined program when activated; and
4) the property of said at least one graphic object arranged to be determined partially by the location of said device, the pointing direction of said device, said plurality of contents, and/or the time when said button is activated.

16. The method according to claim 15, further including providing options for a user to edit the property of said button, said at least one graphic object, and/or said window.

17. The method according to claim 15, further including presenting a plurality of graphic icons when said at least one graphic object is activated, said plurality of icons arranged for performing respective functions or starting respective applications or programs individually when activated.

18. The method according to claim 15, further including making said at least one graphic object or said window disappear if said button is activated again within said given short period of time.

19. The method according to claim 15 wherein said button is arranged on said display for a predetermined time period.

20. The method according to claim 15 wherein the appearance of said button is arranged to change automatically.
